(19) United States
(12) Patent Application Publication
(10) Pub. No.: US 2004/0084566 A1
(43) Pub. Date: May 6, 2004

(54) Multi-nozzle grid missile propulsion system

(76) Inventor: Daniel Chasman, Tucson, AZ (US)

Correspondence Address: Welsh & Katz, Ltd., 22nd Floor, 120 South Riverside Plaza, Chicago, IL, 60606, US

(21) Appl. No.: 10/288,943

(22) Filed: Nov. 6, 2002

(51) Int. Cl. B64B 1/36

(52) U.S. Cl. 244/74

(57) ABSTRACT

A jet propulsion outlet device is disclosed that has a grid plate having a plurality of densely clustered nozzlettes, the nozzlettes of the grid plate being configured to operably couple to a pressurized gas source to efficiently expand the pressurized gas.

### CROSS REFERENCE TO RELATED APPLICATIONS

This application claims the benefit of priority to the U.S. Provisional Application entitled MULTI-NOZZLE GRID MISSILE PROPULSION SYSTEM filed on Nov. 4, 2002 by Daniel Chasman.

### BACKGROUND OF THE INVENTION

The field of the subject invention are jet propulsion systems, and more particularly the invention pertains to the use of a multi-nozzle grid to direct transonic and supersonic flows in rocket motors for use in propulsion.

Jet propulsion uses the momentum of ejected matter to propel a vehicle or device, the ejected matter usually being predominately a gas. Rocket motors are one of the most common applications of jet propulsion. Rocket motors propel vehicles or devices called rockets or missiles.

It is generally appreciated that it is desirable to have jet propulsion engines that enhance the flight characteristics of the vehicle. Stability in flight is aided by having the center of gravity ahead of the center of aerodynamic pressure. Otherwise, alternative means of adding stability, such as tail fins, must become necessary to achieve a desired level of stability.

Rocket motors most commonly burn solid (“solid rocket motor” or “SRM”) or liquid (“liquid rocket motor” or “LRM”) fuels contained in the rocket to produce very high temperature gasses which are ejected from the rocket engine at several times the speed of sound. Conservation of momentum requires that the increased rearward momentum of the gas impels the motor or engine, along with its vehicle, forward. It is desirable to have engines that maximize this transfer of momentum by maximizing the speed of the ejected matter.

The length of operation for an engine is also important. A rocket engine needs to operate long enough to accomplish an objective, such as delivery of a payload. Accordingly, jet propulsion engines that offer longer operational periods are desired. Longer operation can occur through longer survival of the rocket engine under the stresses of extremely hot and high pressure fuel, or from a weight savings that allows a fixed amount of fuel to be used over a longer period of time.

There is a premium placed on being able to provide jet propulsion systems with nozzles that have low energy losses, small, short, and light in weight. Examples of energy losses that are frequently contemplated include, but are not limited to, internal wall friction losses with the propellant, external aerodynamic drag with the atmosphere, and heat transfer from the propellant gas to the engine. Radial velocity component losses can occur when kinetic energy is lost due to the sideways (radial) motion of the gas relative to the axis of the engine. The flow of the propellant gas over engine surfaces can also lead to separation, turbulence, and divergence losses.

The behavior of jet propulsion is dependent on in the engine. Nozzles generally can have a convergent section where the nozzle accepts gasses, a throat which is the most constricted part of the nozzle, and a divergent section where gasses are expanded prior to being expelled from the engine. Some nozzles may have only convergent or divergent sections, however such nozzles will not have practical uses for gasses expelled at supersonic speeds.

In the case of gasses expelled at supersonic speeds, the selection of the parameters for the divergent nozzle are more important than the convergent nozzle. Other general consideration in jet propulsion engine design include allowing for the fact that discontinuities on the walls of the engine are likely to give rise to energy losses from shock waves, so all nozzle sections should be well rounded. The exit portion of the divergent section usually has a sharp edge because a rounded edge would permit overexpansion and flow separation in the expelled gases.

As a rule of thumb, when using a common conic nozzle geometry for the longitudinal profile of a nozzle, a half angle of less than 24° is used for the convergent nozzle and 15° half angle for the divergent nozzle. In most conventional designs these specifications are compromised due to length, diameter, or weight limits.

Like the use of a single conventional nozzle, the use of multiple conventional nozzles in rocket design is known, but not favored by those of ordinary skill in the art. Multiple conventional nozzles have been used when the geometry(i.e., length) or weight of a single conventional nozzle was prohibitive. While the concept has been generally limited to small tactical missiles in the western hemisphere, the use of multiple conventional nozzles was applied even for space exploration in the eastern hemisphere, especially in the Soviet Union. Yet, the use of multiple conventional nozzles is generally considered by those of ordinary skill in the art to be less efficient than using a single nozzle. Because increasing the number of nozzles is generally thought by those of ordinary skill in the art to increase inefficiencies, even when multiple conventional nozzles are used, the use is usually limited to four to six nozzles at most to minimize the generally perceived disadvantages of multiple nozzles.

An early use of a plurality of small nozzles (“nozzlettes”) was applied in a supersonic wind tunnel in Germany during the 1930s to overcome length limitations [1]. The construction was to place a rectilinear grid of orifices in a substantially rectangular wind tunnel. The use of multiple nozzlettes achieved a length savings, but forced the designers to use a settling chamber with the length of an equivalent single nozzle because the Germans did not have a knowledge of fluid dynamics that would permit them to control the scale and decay distance of turbulence by the selection of the number and size of nozzlettes.

Typical problems of conventional jet propulsion engine design include geometrical limits imposed on the nozzle length and/or diameter, the weight limitations of an efficiently designed ideal single nozzle, the requirement of the selection of heavy material for throat design and the deleterious aerodynamic effects of an aft shifting of center of gravity on the aerodynamic stability of the air vehicle. As a result, a design procedure that allows dramatically increased performance, adherence to theoretically superior nozzle geometries, and reducing weight while also cutting the cost and time to manufacture jet propulsion engines would meet needs not met adequately by current technology.

### SUMMARY OF THE INVENTION

The present invention relates to an improved nozzle system for use in propulsion. One aspect of the present invention relates to methods of designing multiple nozzlette plates for use in propulsion. Another aspect of the present device is a multi-nozzle grid for use in jet propulsion, whether rocket, jet turbine, or other, that provides structural integrity to a jet propulsion device while aiding the management of drag from the gas ejected to propel a device.

One aspect of the present invention is a jet propulsion outlet device comprising a grid plate having a plurality of densely clustered nozzlettes, the nozzlettes of the grid plate being configured to operably couple to a pressurized gas source to efficiently expand the pressurized gas.

In a preferred embodiment of the present invention concerns a jet propulsion outlet device with a plate that is made from a material from the group consisting of glass reinforced phenolic composites, graphite reinforce phenolic composites, short strand reinforced phenolic composites, fiber reinforced ceramic matrix composite, and ceramic composites .

In another embodiment of the invention, the jet propulsion outlet device has nozzlettes that are disposed in a pattern having a port to nozzlette ratio of greater than one.

In a further embodiment of the invention, the jet propulsion outlet device wherein the nozzlettes are made of a material that will remain substantially intact after having a gas stream having a pressure of 14,000 psi and a temperature of 2000° C. for 120 seconds passed through the nozzlettes.

In yet another embodiment of the present invention, the jet propulsion outlet device has at least one centrally disposed nozzlette surrounded by a plurality of peripheral nozzlettes, each of the plurality of peripheral nozzlettes abutting at least one central nozzlette and at least two other peripheral nozzlettes.

In another embodiment of the present invention, the jet propulsion outlet device has nozzlettes that are disposed in a pattern such that when a pressurized gas is passed through the nozzlettes, the pattern is substantially free of stagnation zones and the pressurized gas is not subjected to flow turning.

In a further embodiment of the present invention, the jet propulsion outlet device has nozzlettes where the convergent portion of the nozzlettes converges at an angle of less than 48°, and the divergent portion of the nozzlettes diverges at an angle of less than 30°.

Another aspect of the present invention relates to methods of designing a nozzlette grid for channeling a gas comprising the steps of:

providing design parameters;

determining a required plate thickness based on the design parameters;

determining a geometry of an equivalent single nozzle;

defining geometric pattern to pack the nozzlettes in a tight arrangement; and

selecting a number of nozzlettes; wherein

the design for the nozzle grid defines a plate having the required plate thickness having the plurality of nozzlettes with the geometry of the equivalent single nozzle disposed in the geometric pattern.

In a preferred method embodying the present invention, the design parameters include parameters related to mechanical and thermal stresses associated with the application of a gas to the nozzlette grid and the materials properties of a material.

In a further method embodying the present invention, the geometric pattern is such that when a pressurized gas is passed through the nozzlettes, the defined plate is substantially free of stagnation zones and the gas is not subjected to flow turning.

Another aspect of the present invention is related to missiles having improved aerodynamic stability having a payload, a propellant, and an engine comprising a plate having a plurality of nozzlettes disposed in a pattern that reduces stagnation zones in the engine. The missile also has a center of gravity of the payload, engine, and unexpelled propellant, where the center of gravity being spaced from the engine. The missile also has a center of aerodynamic pressure, the center of aerodynamic pressure being located closer to the engine than the center of gravity.

A preferred embodiment of the present invention relates to a missile in which the engine has a center of gravity that is further forward than that of an equivalent single nozzle engine made from the same material.

Another aspect of the present invention relates to a missile comprising a payload and a propellant, the propellant being capable of being a pressurized gas. The missile also has an engine comprising a grid plate having a plurality of densely clustered nozzlettes, the nozzlettes of the grid plate being configured to operably couple to a pressurized gas source to efficiently expand the pressurized gas.

In a preferred embodiment of the present invention, a missile has a motor having a mass less than that of an equivalent single nozzle engine made from the same material.

In another embodiment of the present invention, the missile has a plate that is made from a material from the group consisting of glass reinforced phenolic composites, graphite reinforce phenolic composites, short strand reinforced phenolic composites, fiber reinforced ceramic matrix composite, and ceramic composites .

In yet another embodiment of the present invention, the nozzlettes of the missile are made of a material that will remain substantially intact after having a pressurized gas having a pressure of 14,000 psi and a temperature of 2000° C. for 120 seconds passed through the nozzlettes.

In still another embodiment of the present invention, the missile has at least one centrally disposed nozzlette surrounded by a plurality of peripheral nozzlettes, each of the plurality of peripheral nozzlettes abutting at least one central nozzlette and at least two other peripheral nozzlettes.

In a further embodiment of the present invention, the missile has nozzlettes that are disposed in a pattern such that when a pressurized gas is passed through the nozzlettes, the pattern is substantially free of stagnation zones and the pressurized gas is not subjected to flow turning.

In a yet further embodiment of the present invention, the convergent portion of the nozzlettes converges at an angle of less than 48°, and the divergent portion of the nozzlettes diverges at an angle of less than 30°.

The present invention has several benefits and advantages.

The methods and apparatus of the present invention can be used to reduce the length and weight of gas inlet and outlet management devices for jet propulsion. This in turn can provide jet propulsion engines, including rockets and turbines, having superior specific impulse characteristics.

The present invention can also be used to control the scale and decay-distance of turbulence in jet propulsion.

The present invention can provide missiles having improved aerodynamic stability.

The present invention is capable of sustaining reasonable burn times for rocket propulsion.

The present invention is capable of provide superior structural strength in jet propulsion application, while providing other benefits such as preventing the intake of foreign objects into jet turbine engines.

Still further benefits and advantages of the invention will be apparent to the skilled worker from the discussion that follows.

### BRIEF DESCRIPTION OF DRAWINGS

In the drawings forming a portion of this disclosure:

FIG. 1 is a bottom perspective view of a missile embodying the present invention;

FIG. 2 is a bottom perspective view of a rocket motor embodying the present invention

FIGS. 3A-B are sectional views of flat (3A) and convex (3B) grid plates embodying the present invention;

FIG. 4 is a perspective view of a single nozzle illustrating varying efficiency levels of single nozzle of different lengths;

FIG. 5 is a schematic of a single nozzle illustrating many of the parameters that are used to define such a nozzle;

FIG. 6 is a diagram of the arrangement of circles within a circle to provide a centrally disposed pattern of nozzles;

FIG. 7 is an illustration of prior art conventional multiple nozzle arrangements;

FIG. 8 is an illustration of nozzlette arrangements of the present invention;

FIGS. 9A-B are above and side schematics of a tested one nozzle configuration;

FIGS. 10A-B are above and side schematics of a tested seven nozzlette configuration; and

FIGS. 11A-B are above and side schematics of a tested nineteen nozzlette configuration.

### DETAILED DESCRIPTION OF THE INVENTION

Although the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

It is to be further understood that the title of this section of the specification, namely, “Detailed Description of the Invention” relates to a requirement of the United States Patent and Trademark Office, and is not intended to, does not imply, nor should be inferred to limit the subject matter disclosed herein or the scope of the invention.

FIG. 1 shows an embodiment of the present invention in the form of a missile 10. The missile 10 of FIG. 1 is a single-stage rocket having a tail section 12. The tail section has a source of pressurized gas 14 or other expelled matter operably connected to a multi-nozzle grid plate(referred to as “multi-nozzle grid” or “MNG”) 16 through which the expelled matter is sent. Often, this operable connection is a chamber 18 located between the source of pressurized gas 14 and the MNG 16. The missile can optionally have aerodynamic elements such as fins 20 to add stability or steering capabilities in flight. As will be understood by those of ordinary skill in the art, a missile can comprise one or more stages each having a tail section 12, and each tail section having a pressurized gas source 14 and a nozzle grid 16.

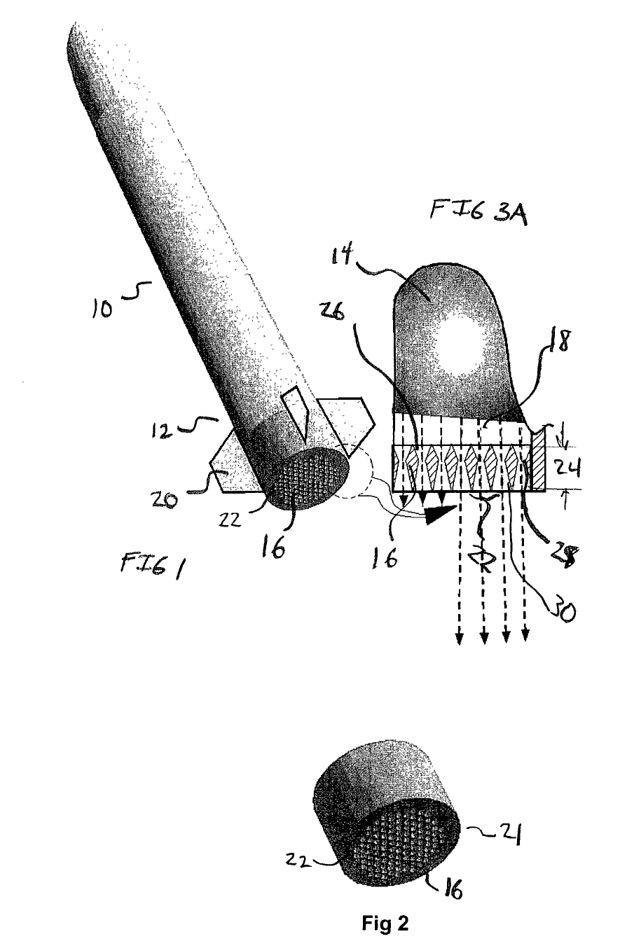

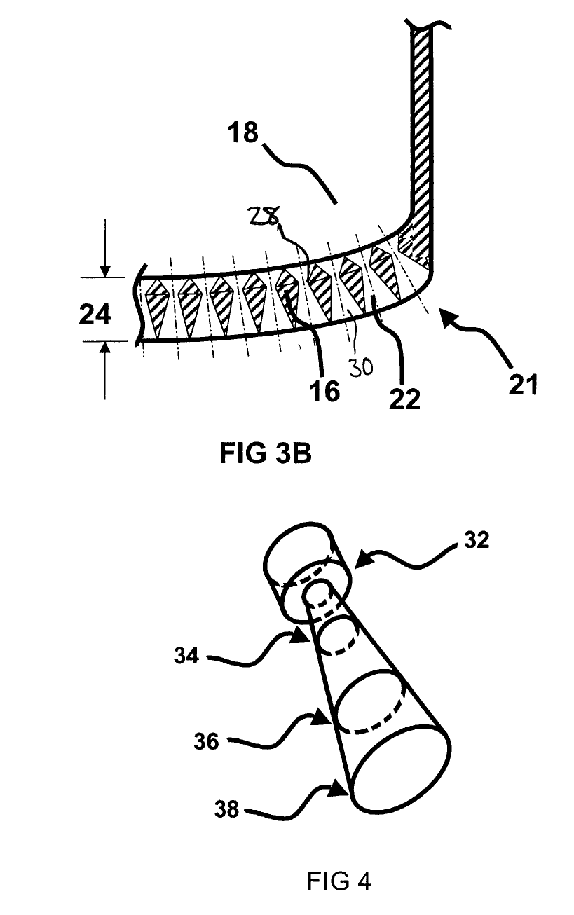

FIG. 2 is a bottom perspective of a MNG 16 engine 21 (or motor, or more generally than rockets, outlet device) of the present invention having 201 nozzlettes 22 and defining a chamber 18. Referring to FIGS. 3A&B, the MNG 16 has a thickness 24. FIG. 3A shows a flat partial cross-section of the nozzle grid 16 of FIGS. 1 & 2, each nozzlettes 22 can have a convergent section 26, a throat 28 and a divergent section 30. The source of pressurized gas 14 directs pressurized gas through the nozzlettes 22 to propel the missile 10. FIG. 3B shows a MNG 16 that rather than being flat has a convex geometry.

A MNG 16 can be specified through a design procedure that uses:

1) structural stress analysis and heat transfer analysis that take into account the properties of a selected material to determine the thickness 22 required of a MNG plate 16 for a given set of operating parameters such as, but not limited to: the pressure of the source of gas in the tail section, the combustion temperature and the burn-time;

2) internal ballistics principles and ideal nozzle design to determine the geometry of ‘an equivalent single nozzle’ (i.e., as if designing for a single nozzle rocket motor, jet turbine or other engine); and

3) a geometric pattern to pack nozzlettes 22 (of the shape defined above) in a tight arrangement that can reduce or eliminate stagnation zone losses and flow turning losses. This nozzlette arrangement is made within the plate thickness 24 found in step 1. This procedure provides the number of the nozzlettes 22 of the MNG 16.

The design procedure described above can specify a MNG plate 16 that is thinner and lighter than a single nozzle. The length saving is in proportion to the square root of the number of the nozzlettes 22 in the MNG 16(i.e., a MNG with 100 nozzlettes is about 10 times thinner than an equivalent single nozzle). When the nozzlettes 22 are disposed in a pattern as contemplated by the present invention, the multi nozzle grid 16 reduces energy losses to flow speed losses and heat transfer losses. The present invention's placement of the nozzlettes 22 reduces or eliminates stagnation zones. Further, the MNG 16 accomplishes the reduction of stagnation zones while providing a structural element that can provide structural stability to a device such as a missile 10, turbine, or other kind of jet engine. It is also thought that the a MNG 16 of the present invention reduces flow turning at the outlet of the engine, and thereby avoids losses owing to drag and heat transfer inherent in turning a gas stream.

In one field of application of the present invention, there are many missiles 10 that could improve performance and reduce production cost by using a MNG 16 configuration instead of rocket nozzles of the prior art. As an example of that application, one type of missile 10, interceptors, can improve their terminal velocity or reduce mass and size for the same performance.

Alternatively, an interceptor missile that achieves a high burnout velocity, if designed with a MNG 16, might be small enough to fit into existing platform instead of going to a larger platform. However, the example is not limited, and the MNG 16 of the present invention can be used for both tactical and ballistic missiles 10.

As those of ordinary skill will appreciate, an accurate quantification of the improvement can only be presented for a specific configuration and a set of requirements. It is thought, based on generalized estimates, that large missile 10 configurations can demonstrate 20% to 30% improvement in performance or mass reduction, while small missile 10 configurations can even show as much as 50% improvement.

The MNG 16 design procedure has been used successfully in tactical missiles 10 using both stainless steel and short strand glass reinforced phenolic composite. The recent arrival of heat-resistant materials (for hypersonic flight of scramjet engines, turbine and wheel brake pads of passenger airplanes) provides an inventory of heat- and erosion-resistant materials that can operate much longer than practical application, such as, but not limited to, missile defense interceptors require.

FIGS. 2-3 presented embodiments of the present invention as advanced rocket motors with an MNG 16 configuration. FIG. 4 shows a conventional single-nozzle rocket motor 32 having three possible different lengths for the single nozzle. First, a practical single nozzle 34, which signifies a conventional engineering choice, is seen as the shortest embodiment. An optimal single nozzle 36, which can be defined as being adapted for an anticipated expansion ratio where the exit pressure equals the ambient pressure, is longer. Last, an equivalent single nozzle 38 that is proportionally sharing identical geometrical properties with each individual nozzlettes 22 of the MNG 16 is the longest.

While the advanced rocket motor 21 of FIG. 2 consists of a compact chamber 18 with a MNG plate 16 that is short, compared to the longer equivalent single nozzle 38 of FIG. 4, the details of FIGS. 3A-B reveal that the MNG 16 has many nozzlettes 22. These nozzlettes 22 can have the same scaled-geometry as that of the equivalent single nozzle 38 of FIG. 4.

As an illustration of the benefits of the present invention, an application of the MNG 16 to solid fueled rocket motors (SRMs) is considered. However, application of the principles of the present invention is not limited to SRM design. And can be applied to other types of rocket propellants such as liquid fuel propellants as well as several applications in other engines, including, but not limited to, the jet turbines to be discussed.

A conventional SRM with a practical single-nozzle 34 (i.e., one that considers mass and geometric limits) must be much shorter than that of the equivalent single nozzle 38 because of the expansion ratio limits. These limits are controlled by several factors, including, but not limited to, 1) missile diameter; 2) ambient pressure outside the rocket; and 3) the reduction in missile velocity due to the extra weight of an added portion of the nozzle [4. Regarding mass properties considerations that are generally very important to missile design, a lighter aft body improves aerodynamic static stability by moving the center of gravity forward. Alternatively, length saving obtained can provide improved performance by simply adding more propellant.

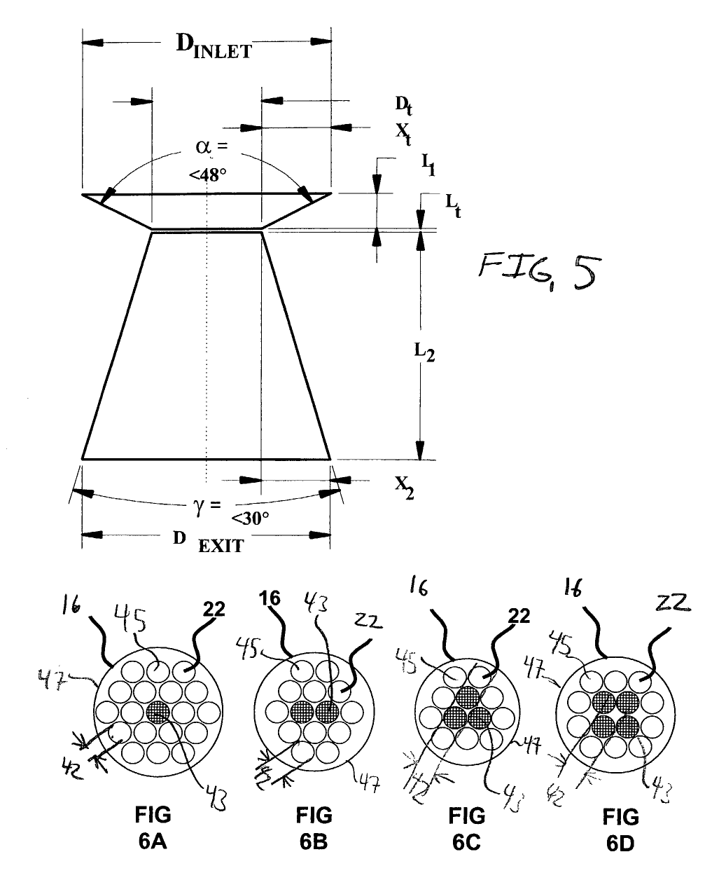

The multi nozzle grid 16 design procedure includes a equivalent single-nozzle design 40 illustrated in FIG. 5. The design also considers the thrust coefficient, Cf, which is an important element in ideal nozzle design, that relates the predicted performance and requirements to nozzle geometry. As those of ordinary skill in the art will appreciate, handbooks of solid rocket design [4, 5, 6, 7, 8] detail ways to design nozzles such that the thrust coefficient is optimal. As a last component, the geometric design procedure of the MNG procedure is also included.

First, the effect of nozzle geometry on C_{f} should be understood. The pressure ratio in the equation for C_{f} below is an internal ballistic parameter and relates the chamber pressure to the exit pressure. When the nozzle is designed optimally (i.e., P₂=P₃, or synonymously, P_{@exit}=P_{@ambient}) the second term in the equation for C_{f} is omitted and C_{f} can be expressed by the first term only. It should be noted that it is possible for the benefits of the present invention to be realized with both optimally and non-optimally designed nozzles, although those of ordinary skill in the art will appreciate that more optimal rather than less optimal solutions are generally preferred.

The second term is applicable in two cases: 1) P₂>P₃ for under-expanded nozzle, or 2) P₂<P₃ for over-expanded nozzle. Nozzles with exceptionally high expansion ratios are usually useful for exo-atmospheric applications. When P₃=0 (i.e., the vacuum of space) there is no limit of over expansion. However, when P₂<P₃ the nozzle is not efficient because the flow separation due to negative pressure on the nozzle exit tips, reduces the effective expansion ratio.

$${C}_{f} = \sqrt{( 2 \cdot \frac{{k}^{2}}{k - 1} ) \cdot {( \frac{2}{k + 1} )}^{\frac{k + 1}{k - 1}} \cdot [ 1 - {( \frac{{p}_{2}}{{p}_{1}} )}^{\frac{k - 1}{k}} ]} + [ ( \frac{{p}_{2}}{{p}_{1}} ) - ( \frac{{p}_{3}}{{p}_{1}} ) ] \cdot ϵ ( {p}_{2} )$$

$$Eq . 3 \text{-} 30 , p . 59 [ 6 ]$$

Mathematically, the second term is then negative and the value of C_{f} diminishes. At sea-level operation or low altitude flights, the over-expanded nozzle is wasteful and an under-expanded nozzle is more practical, not only because C_{f} cannot be reduced further by the Pₑ−Pₒ term, but also because the geometric area ratio of the exit to throat (ε) limits. This is also true to jet turbine and some other non-rocketry applications of the present invention. This ratio (ε), which is limited by length constraints in conventional nozzle design, can be exploited using the MNG configuration.

The last section combined with elements in the methodology compares theoretical C_{f} versus experimental C_{f} to illustrate the trade-off of using the multi nozzle grid design procedure over single-nozzle design. All of these considerations apply to conically shaped nozzles, but can be modified and then apply to contour-shaped nozzles having various shapes known to those of ordinary skill in the art, or even those yet to be known.

The design of the MNG can begin with a standard single-nozzle design as shown in FIG. 5. This equivalent single nozzle design 40 can conform to all the textbook design criteria for nozzles such as, but not limited to, those known to those of ordinary skill in the art [4, 5, 6, 7, 8, 9]. This step can also beneficially include calculations of burn surface and initial void-volume in the chamber. MNG design is especially sensitive to void volume changes due to its significant reduction in convergent nozzle volume. Void volume controls the initial pressure transient and can be easily obtained using ref. [9]. FIG. 5 shows an equivalent single nozzle. The MNG procedure can describe this equivalent single nozzle according to the following equations:

$$\begin{matrix}{A}_{t} = π \cdot \frac{{D}_{t}^{2}}{4} ; & Eq . ( 1 ) \\ {A}_{t} ≡ n \cdot {A}^{*} = n π \cdot \frac{{( {d}^{*} )}^{2}}{4} ; & Eq . ( 2 )\end{matrix}$$

Where Aₜ is the throat area of the equivalent single nozzle with diameter of Dₜ, and A* is the throat area of the n^{th} single nozzlette in MNG with diameter d*. Further manipulation of these equations leads to the following expression:

$$π \cdot \frac{{( {D}_{t} )}^{2}}{4} = n π \cdot \frac{{( {d}^{*} )}^{2}}{4} ⇒ {D}_{t} = \sqrt{n} \cdot {d}^{*} . \qquad Eq . ( 3 )$$

Similar relations can be derived for the exit diameter (Dₑₓᵢₜ) and the inlet diameter (Dᵢₙₗₑₜ).

Next, a relation will be derived for the length of a nozzle, following the notations in FIG. 11:

$${L}_{1} \cdot Tan ( \frac{γ}{2} ) = {x}_{1} where {x}_{1} = \frac{{D}_{inlet} - {D}_{t}}{2} ⇒ {L}_{1} = \frac{( {D}_{inlet} - {D}_{t} )}{2 \cdot tan ( \frac{γ}{2} )} \qquad Eq . ( 4 )$$

Generally, γ will be less than 30°. Similarly, an expression is derived for L₂ (i.e., the length of the divergent nozzle):

$$\begin{matrix}{L}_{2} \cdot Tan ( \frac{α}{2} ) = {x}_{2} where {x}_{2} = \frac{{D}_{exit} - {D}_{t}}{2} ⇒ {L}_{2} = \frac{( {D}_{exit} - {D}_{t} )}{2 \cdot tan ( \frac{α}{2} )} & Eq . ( 5 ) \\ \begin{matrix}\begin{matrix}Where α is generally less than {48}^{∘} . Since \\ L = {L}_{1} + {L}^{*} + {L}_{2} and L * \to 0 and {D}_{e} ≡ {D}_{exit} = {D}_{inlet}\end{matrix} \\ ⇒ L = \frac{( {D}_{e} - {D}_{t} )}{2} \cdot ( cot ( \frac{α}{2} ) + cot ( \frac{γ}{2} ) ) .\end{matrix} & Eq . ( 6 )\end{matrix}$$

Define the throat to exit area ratio

$$ϵ = {( \frac{{D}_{e}}{{D}_{t}} )}^{2} ≡ {( \frac{{d}_{e}}{{d}^{*}} )}^{2} ,$$

and

Dₑ=\sqrt{ε}·Dₜ Eq. (7),

then Eq. (6) can be redefined as:

$${L}_{SN} = {D}_{t} \cdot \frac{( \sqrt{ϵ} - 1 )}{2} \cdot ( cot ( \frac{α}{2} ) + cot ( \frac{γ}{2} ) ) . \qquad Eq . ( 8 )$$

The Total Length of an equivalent single nozzle is then a function of the throat diameter, the exit to throat area ratio, the converging and diverging half angle. Eq. (8) directly applies to the MNG design by substituting d* for throat diameter:

$${L}_{MNG} = {d}^{*} \cdot \frac{( \sqrt{ϵ} - 1 )}{2} \cdot ( cot ( \frac{α}{2} ) + cot ( \frac{γ}{2} ) ) . \qquad Eq . ( 9 )$$

Taking the ratio between Eq. (8) and Eq. (9) and then substitute Eq. (3) defines the saving in length of the MNG concept:

L_{SN}=\sqrt{n}·L_{MNG} Eq. (10)

Eq. (10) shows that the length saving of MNG configuration is proportional to the square root of the number of nozzlettes selected. For example, MNG with 196 nozzlettes will be about fourteen (14) times shorter than that of an “equivalent single nozzle.” For example, one MNG configuration was successfully tested used 201 nozzlettes. Eq. (10) then helps quantify the large value of length saving can be achieved by increasing the number of nozzlettes in the MNG configuration.

There is a limit to the length savings, however, that can be estimated via heat-transfer and stress analyses that calculate of the minimum thickness of an MNG base-plate (L_{MNG}), following standard design procedure (i.e., taking safety factors into account, etc.). Specifically, tensile and shear strengths on the selected material and the geometry (diameter, length etc.) determine the thickness [17]. Most materials show deterioration of the tensile and shear strengths as a function of wall temperature (i.e., stagnation temperature of the working fluid in the chamber). This temperature-related weakening of the material selected increases the minimum required thickness of the MNG base-plate (L_{MNG}).

Then, the maximum number of nozzlettes can be determined by how many nozzlettes can be fit into this thickness. Following standard design procedure (i.e., safety factor, etc.), the maximum number of nozzlettes is determined thereafter [10]. Knowing now both L of an equivalent single nozzle and L_{MNG} yields:

$$n = {( \frac{L}{{L}_{MNG}} )}^{2} . \qquad Eq . ( 11 )$$

Other benefits in selecting large number of nozzlettes are the resulting increase of the local port to nozzlette ratio and the potential to reduce the stagnation areas and consequently minimize heat losses. Port area is defined by the cross-sectional area of hot gases and combustion particulate from the surface of the solid propellant or the liquid injectors of oxidizers and fuels towards the nozzle throat. In the best circumstances, the flow converges, unobstructed from rest in the far flowfield to sonic speed in the nozzle throat. In solid rockets the burn surface (analogous to the far flowfield) is changing and the reference area that defines the starting line progressively recedes away from the initial burn surface.

As will be recognized by those of ordinary skill in the art, the burn surface is not always limited to burn-back configuration (i.e., where the flow proceeds away from the burn surface that is perpendicular to the nozzle throat, in a straight line from the surface until it exit through the nozzle). More often than not, the burn surface is parallel to the centerline. For example, a tube geometry or a cluster of tubes where the burn surface is mostly occurring on the internal or external round surfaces. In this case, the flow is forced to turn in a right angle before being accelerated towards the nozzle. Unlike the “burn-back” geometry, the port in this case does not match the burn surface. Instead, the burn surface is the tube internal surface plus the ring facing the nozzle (assuming the outer surface is bonded to the chamber pressure wall), while the port is the cross section area of the flow exiting the tube on its converging way towards the nozzle throat. In more complex propellant geometries (i.e., wagon wheel, dendrite, tube cluster, etc.) the port area still conforms to that definition (i.e., the combustion chamber internal cross section minus the obstruction area).

From ideal gas considerations, the port to nozzle ratio should go to infinity [7]. In practice however, value close to one are most common. Local port to nozzle ratio in MNG geometry refers to the contribution of a single nozzlette It is therefore easy to see that when the number of nozzlettes increases this ratio goes to infinity.

FIGS. 6A-D show four exemplary arrangements of circular nozzlettes 22 within a circular nozzle grid plate 16. Of the four, FIG. 6A provides the most tightly packed grid having nineteen nozzlettes. The small circles represent the exit diameter 42 of each nozzlette 22 and can be calculated following the equations given above. These formulae are known for other purposes to those of ordinary skill in the art, for example, the formula to define Pattern A in FIG. 6 being defined in ref. [11].

Preferably, the nozzlette 22 pattern comprises a core of centrally disposed nozzlettes 43 surrounded by one or more rings or layer of peripheral nozzlettes 45. Also preferably, the centrally disposed nozzlettes will have a high degree of symmetry to add stability to the in-flight stability of the rocket. More preferably, as shown in FIGS. 6A-C, the nozzlettes are disposed in a hexagonal arrangement. As shown in FIG. 6A, there is but one central nozzlette, giving rise to an arrangement of a hexagon with three nozzlettes on a side. An alternative arrangement, more diamond-shaped than FIG. 6A, shown in FIG. 6B is less symmetrical, more like a diamond shape, but still contemplated by the present invention The arrangement shown in FIG. 6C has a triangular arrangement of centrally disposed nozzlettes 43 that gives rise to a more generally triangular nozzlette pattern. The arrangement in FIG. 6D is more rectangular than FIG. 6A.

As can be observed, the approach to form a densely clustered pattern of nozzlettes is to have as many nozzlettes packed substantially as tightly as practical. Generally, the centrally disposed nozzlettes can be arranged to touch in a touching or almost-touching formation, as seen in FIGS. 6B-6D. A maximum number of peripheral nozzlettes can then be placed adjacent to and abutting the central nozzlettes to maximize the density of nozzlettes in a port area 47. Most preferably, if other design considerations allow, the nozzlette pattern will substantially span the port area 47.

The calculations of C_{f} can follow the formulation detailed in reference [6], section “Thrust and Thrust Coefficient,” p. 58-63. Chamber pressure (P₁) is constant while the exit pressure is allowed to vary in order to generate a series of C_{f}'s, ε's and F's. The mass flow rate, wdot (usually depicted in texts as a w with a dot over it and having often units of lb/sec) is a constraint based on density and burn-time. The throat area Aₜ (in²) is calculated using the designed nozzle diameter d(Aₜ=π·d²/4). For a known exit area, Aₑ/Aₜ determines which of the nozzle expansion ratios (ε) is appropriate. The burn area to throat area ratio, Kₙ, is also calculated based on equation 11-13, p. 384 [6]. The calculations can be done by hand, or more conveniently using commercially available software such as Mathcad.

Design practice directed to the use of multiple distinct nozzle bodies, as opposed to Multi Nozzle Grid one, has been used since early rocketry. Rocket scientists who engaged in internal ballistics calculations or mechanical engineers who designed the rocket hardware have noticed that by replacing a single nozzle with multi nozzle design precious overall length is saved. This has especially been noticeable in launch-tube rockets. The length saving have provided the options of mass saving or alternatively using the saved length to add it to the pressure chamber and thus add more propellant to the rocket without changing the rocket overall length.

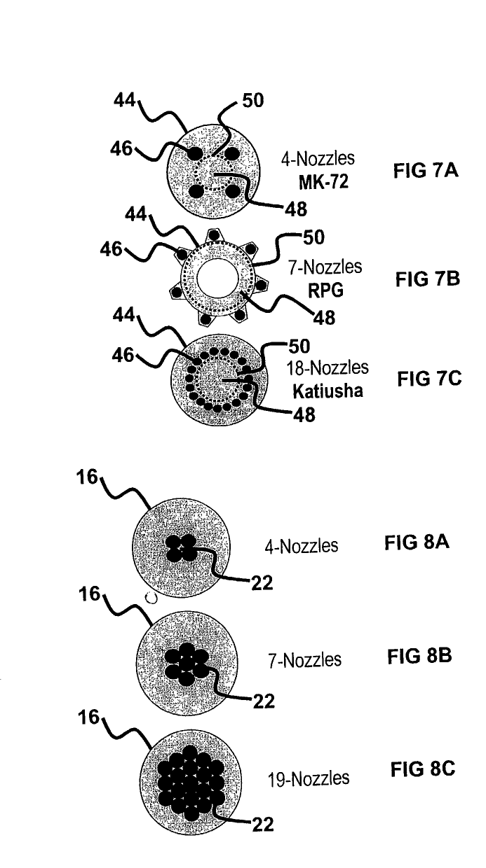

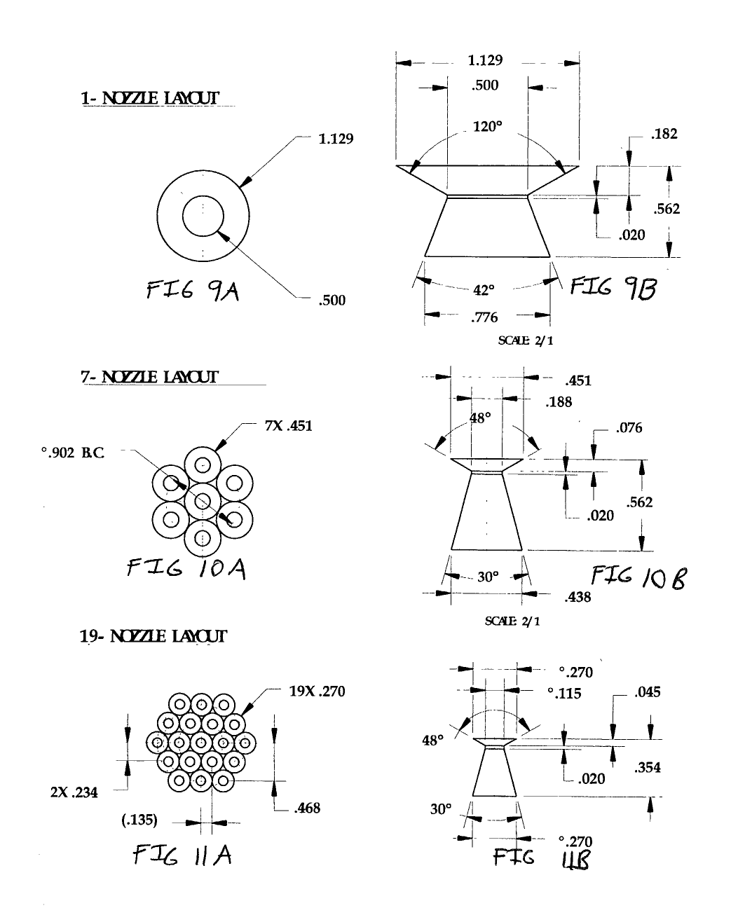

But without a systematic approach to multi nozzle design, inferior geometry and inferior material selection gave multiple independent nozzle designs a reputation as being heavy, less efficient and often risky alternative to single nozzle design. FIGS. 7 & 8 illustrates this point in relations to the MNG configurations. As shown in FIGS. 7A-C, rocket motors 44 with multi nozzle arrangement away from the center (i.e., from 18 nozzles 46 in a circle close to the circumference in the Russian made Katusha (FIG. 7C) to a four nozzles 46 in the MK 72 (FIG. 7A) and many other multi nozzle examples) suffer from losses due to the flow turn from the center to the orifices away of the centerline 48. The flow losses don't reduce the overall efficiency as much as the heat losses because of the flow turning. Since heat in SRMs distributes with the flow, it is concentrated in the centerline from the stagnation zone 50 in the head end to the throat in the aft end to the exit cone and all the way through the plume.

By creating a stagnation zone 50 in the centerline of the SRM, heat dissipates into the aft end of the pressure chamber. Referring to FIG. 8, in order to avoid these losses in multi nozzle design, the stagnation area 50 is minimized by clustering the nozzlettes closely, preferably as closely as possible. Similarly, many tactical SRM configurations that use Copper infiltrated Tungsten for multi nozzle inserts, which are very heavy, and augments the center of gravity of the missile to move aft. Moving the center of gravity aft is not a desirable characteristic because it reduces aerodynamic stability. In contrast, using composite material, which has the best stress to density ratio or combination of the later with ceramics would not only be a good solution for long duration of thermal protection for the MNG, but also significant improvement in the aerodynamic stability by moving the center of gravity position forward.

Since ancient times, rocket designers have used available rockets, clustered together, to quickly form a much larger unit with longer range. Cluster design consists of separate rockets each having its own combustion chamber and nozzle/nozzles. This practice is probably as old as the first rockets that were produced for the Chinese Emperors millennia ago. When higher fire power or longer range was needed and the only available inventory was of smaller caliber, cluster was a quick fix that represented manufacturing compromise.

Like MNG, cluster is a systematic ‘packaging’ of many small caliber rockets into a single unit. The systematic packaging of many small nozzlettes into a single unit of MNG is quite similar. Since the MNG shares a single combustion chamber, as opposed to the many small caliber combustion chambers of each individual rocket in the cluster, the structural mass saving of the MNG is readily recognized by those of ordinary skill in the art. Calculations show that the MNG with n nozzlettes is lighter than a cluster having the same n number of rockets, same material and overall similar diameter and thrust level.

Composites and other materials with densities similar to that of the propellant are, in general, desirable choices for the rocket motor structure, not only because of the superior yield stress to density ratio composites display, but also because of the effect on the resulting overall mass reduction property of the missile. The present invention is not bound by any particular limit of yield stress to density ratio. It is rather limited by the suitability of the material, which in response to the intense heat can erode excessively and/or unacceptably (i.e. above 10%). Although not limiting, yield stress to density ratio of composites is in the range of 30 to 5 million lbf/lbm are suitable for the present invention as compared to stainless steel which ranges from a million to 100,000 lbf in/lbm, and is not acceptable for all applications of the present invention.

Generally, mass-property experts wish to see the center of gravity location move forward towards the nose for better aerodynamic static stability. In contrast, in rocketry, all-heavy aft-closure and Thrust Vectoring Control systems can destabilize a missile by moving the center of gravity location further aft (sometimes behind the center of pressure) generally requiring compromise of design parameters or the addition of compensating devices, such as fins to stabilize the missile.

MNG technology is preferably made from composite materials. Instead of expensive machining, a matrix akin to mass-produced casting can result in a single part. For example, an MNG plate comprising the MNG and it associated case would drastically reducing production costs. The material is preferably a Glass or Graphite reinforced phenolic composite with or without multi-ply woven fabric inserts. For longer operation, vacuum plasma spray of thin layer of heavy ceramics or metals over the composite matrix can provide beneficial performance characteristics including much longer burn times. As shown in Table 1, below, materials containing or treated with niobium compounds, such as Columbium C103 can provide very long burn times.

Transfer molding of short strand reinforced phenolic with a MNG plate thickness of only ¼ inch has shown to safely last for 5 seconds. Depending on motor diameter, chamber pressure and combustion temperature, use of a 2-inch thick MNG plate can extend the operating time to over 10 seconds. Beyond this time limit, transfer molding with multi-ply graphite woven fabric inserted in the throat area reduces nozzle erosion to 3%. And beyond 40 seconds, ceramic inserts for every individual nozzlettes convergent cone can be placed above the Phenolic impregnated graphite woven fabric in the matrix, before the transfer molding (RTM) process begins. Alternatively, carbon-carbon matrix and ceramic-carbon (C/SiC) composite material [11, 12, 13] can be used to fabricate the whole MNG plate separately or as an integral part of the pressure chamber. Tests operated from 36 to 56 seconds exhibit acceptable results with some nozzle erosion [11, page 228]. Rocket motors for space exploration, which used columbium alloy C103 at a working pressure of 1800 psi and temperature of 2300° F., were reported to operate for over 900 seconds without apparent degradation [12]. More recent studies reported testing material at 1500 psi and an operating temperature of 3000° Kelvin show 21 seconds operation without erosion [13].

Ceramic compounds are silicon based and have exceptional endurance in high temperature applications. Many of the ceramics available for practice in the present invention were developed during the efforts to develop hypersonic flight worthy components during the last few decades, and the suitability of a compound for use in the present invention can be informed from the published literature concerning such development. Some of the ceramic compounds are enriched with carbon, zirconium and metals such as aluminum in order to enhance one property or another. Some ceramics' densities are somewhat higher than composites, but still much lower than that of a metal, leaving them still suitable for practice of the present invention. Heavier metal ceramic (i.e., Rhenium, Tantalum carbide, Hafnium carbide, Hafnium diborate and Hafnium nitride) can be deposited in a thin layer in the process of vacuum plasma spray [14] on lower density materials to obtain some of the benefits of the properties of those materials. Mold sintering production method for ceramics is another option for mass-producing nozzlettes' convergent inserts [11, 12, 13, 15].

Alternatively, multi nozzle grids of the present invention can be made by forming nozzlettes of a suitable material, and embedding them in a plate or assembling them in an array by methods known to those of ordinary skill in the art. However, such design must necessarily take into account the ability of the final product to withstand the streesses of the particular application. For example, with respect to rockets, the assembly must survive the heat and pressure of the propellant being expelled.

Table 1 shows the relative durability of several different materials when exposed to solid rocket burn conditions.

| | | MNG plate | | |
|---|---|---|---|---|
| Burn-Time | Material | thickness | Number of | Nozzle |
| (seconds) | used | (mm) | Nozzles | Erosion % |
| 0.020 | Stainless | 14 | 201 | 7 |
| | Steel | | | |
| 3 | Short- | 14 | 7 | >1 |
| 4 | Strand | 9 | 19 | >1 |
| 3 | glass | 19 | 8 | >1 |
| | Reinforced | | | |
| | Phenolic | | | |
| 21 | Carbon- | n/a | 1 | 0 |
| | Carbon | | | |
| 36 | Carbon- | n/a | 1 | 3 |
| | Carbon | | | |
| 56 | Ceramic- | n/a | 1 | 0 |
| | Carbon | | | |
| 900 | Columbium | n/a | 1 | 0 |
| | C103 | | | |

Suitable materiales materials can include fiber reinforced ceramic matrix composite materials that can be obtained from Ceracom from the Ceramight ENVI fiber reinforced ceramic matrix composite model line. Such products can have 2-D or 3-D fiber weaves, and can be made from, but are not limited to, SiC_{f}/SiC, SiC_{f}/SiC+Si, C_{f}/SiC and matrices: HfC, HfN, TaC, B₄CF. Other suitable materials available from Ceracom include ceramic composites sold under the CERAMIGHT brand. The CERAMIGHT materials can have bending strengths of more than 180 MPa at 20° C., more than 140 Mpa at 1500° C., or more than 80 MPa at 2000° C.

In regard to selecting alloys with elements that are present in the propellant composition caution may be in order: when these elements are introduced to the flow, passing through the nozzle, the melting temperature of the selected alloy may be substantially lowered from that of its specification. Cases where a single nozzle configuration failed because the alloy of an aft closure supporting a graphite nozzle insert melted down are precedent for this problem. Fore example, magnesium in the propellant composition can contribute to the melting of stainless steel alloy during static testing, or aluminized composite propellant can do the same in a case where nozzles fabricated from aluminum alloy were used.

Although the above discussion was with respect to rocket motors specifically, the knowledge above can been useful to MNG applications of the turbines (i.e., a co-axial multi-spool turbine) and super-sonic combustion RAM jets (SCRAM Jet). These further embodiments show that in addition to Solid rocket propulsion there are other technologies that can utilize MNG design [1] because of the combination of heat transfer, fluid dynamics, compact geometry and structural considerations are applicable to those fields as well.

### EXAMPLE 1

### Plume Shortening

Initial static studies only supported a burntime during the experiments that were too brief (10 milliseconds) to account for a proven technology that operate at a reasonable burn-time (i.e., 120 seconds). However, these tests showed that employing large numbers of nozzles saved overall nozzle length by a factor of 14 and the nozzle weight by a factor of 5, while the added turbulence increased combustion efficiency, and eliminated “slivering”, the phenomenon of burning solid propellant slivers or chucks flowing out of the nozzles. Schlieren photograph showed that the exhaust plume observed had a more rapid turbulence decay than was evidenced by the German MNG wind tunnel, which is an advantage for propulsive applications.

### EXAMPLE 2

### Higher Muzzle Velocity

Further studies using the multi-nozzle grid continued to prove the advantages found in Example 1. The studies of Example 2 used a multi-nozzle grid having 201 nozzlettes formed from stainless steel as part of a solid propellant rocket engine. The nozzle length (14:1) and the nozzle weight (5:1) were drastically reduced as compared to practical single nozzles. The MNG tactical booster motor of Example 2 was operated at a pressure of 14,600 psi and is illustrated in FIG. 3. The MNG of Example 2 boosted a missile to a muzzle velocity that was more than 30% higher than a conventional configuration with a practical single nozzle as explained in conjunction with the description of FIG. 4.

### EXAMPLE 3

### Heat Transfer Tests

Unlike the cold flow passing through the MNG wind tunnel in Example 1, observations during rocket motor hot-fire tests showed heat-transfer effects in the rocket chamber. Because of the radial nature of the heat distribution (i.e., hottest in the centerline and coolest in the perimeter) in rockets, the MNG rocket plume was found to be very similar to plume of a single-nozzle configuration and unlike that of conventional multi-nozzle configurations. The results of these tests evidences the need to reduce the stagnation area of conventional multi-nozzle configurations to minimize both heat and flow losses and demonstrates that the MNG procedure satisfies this need. For example, when designers choose a four-nozzle configuration and space them apart, high flow and heat losses occur due to the large stagnation area in the center of the aft closure. An MNG procedure requires clustering these nozzles tightly reducing stagnation zones and the consequent heat and flow losses.

Three configurations of SRM with MNG were successfully tested. All three base-plates were fabricated from short strand fiberglass reinforced Phenolic composite. First, an annular stainless steel holder having means for securing a base plate was provided. One of the configurations tested was a single-nozzle configuration that served as a baseline to compare the multi-nozzle configurations to. Two multi-nozzle configurations were also tested, one having 7 nozzlettes and the other having 19 nozzlettes. Representative maximum working pressures for the tests run were about 600 psi with burn times of about 3 seconds. The physical configurations of the one, seven, and nineteen nozzlette engines are provided in front and size views in FIGS. 14A-B, FIGS. 15A-B, and FIGS. 16A-B respectively.

Analysis of the test data showed that exit-pressure of 7 and 19 nozzlette MNG configurations was higher than that predicted with a single-nozzle design. This finding was correlated to the plate thickness and number of nozzlettes. For example, 19 MNG configuration exit pressure was only expected to be 8.85 psi based on its expansion ratio and geometry (see Table 2). Instead, 30.35 psi was recorded. The low exit pressure of only 3.85 psi for the single nozzle was indicative of flow separation and explains the low thrust coefficient recorded (1.22), typical for the “vena contracts” of a nozzle-less orifice. In contrast, the thrust coefficient of the 19 MNG configuration (1.57) is about 30% higher.

TABLE 2
Test Data vs. Theory

| | |
|---|---|
| Pₑₓᵢₜ [psi] | C_{F} |

| Theoretical | Experimental | Theoretical | Experimental |
|---|---|---|---|
| 24.85 | 3.85 | 1.391 | 1.22 |
| 9.17 | 22.67 | 1.395 | 1.48 |
| 8.85 | 30.35 | 1.392 | 1.57 |

A post-test comparison of the three geometries was conducted, in which expansion ratios, lengths and temperatures were examined. The results are presented in Table 3. A thin ablative layer was apparent on the exposed surfaces of the diverging portion of the nozzle or nozzlettes in all three cases. The most prominent ablation layer was observed in the case of the single nozzle. It was observed that the ablation layer was consistent and uniform in each of the nozzlettes (both in the peripherals and in the center). In the case of the 19-nozzlette configuration, the central nozzlette appeared to be subject to increased ablation. On a relative basis, the 19 MNG baseplate was about 20% lighter than the mass of its 7-nozzlette counterpart and 70% lighter than a single-nozzle design.

TABLE 3
Geometry and Test Data

| | |
|---|---|
| # | L [in] |

| | | |
|---|---|---|
| ε | Nozzle | T [K°] |

| Aₑ/Aₜ | No. | Length | Chamber | Exit |
|---|---|---|---|---|
| 2.496 | 1 | .560 | 2960 | 2150 |
| 5.442 | 7 | .560 | 2960 | 2425 |
| 5.592 | 19 | .350 | 2960 | 2475 |

From the foregoing, it will be observed that numerous modifications and variations can be effectuated without departing from the true spirit and scope of the novel concepts of the present invention. It is to be understood that no limitation with respect to the specific embodiment illustrated is intended or should be inferred. The disclosure is intended to cover by the appended claims all such modifications as fall within the scope of the claims.

Other configurations were developed later that included 8 nozzles. It was tested successfully.

Each of the patents and articles cited herein is incorporated by reference. The use of the article “a” or “an” is intended to include one or more.

### REFERENCES

Other Publication

[1] Parkhurst, R. C., Holder, D. W., “Wind Tunnel Technique”, London, Pitman, 1952.

[2] Sadeh, W. Z. and Saharon, D. B., “Turbulence Effect on Laminar Separation on a Cylinder in Crossflow.” AIAA-87-0361, Reno, Nev., Jan. 12-15, 1987.

[3] Chasman D., “The Effect of Turbulence on Flow past a Circular Cylinder at Subcritical Reynolds Numbers.” Master thesis, Colorado State University, Ft. Collins, Colo., March 1982.

[4] Seifert, H., and Summerfield, M., “Space Technology”, H. Siefert ed. pp. 14-26, N.Y., John Wiley and sons, Inc., 1959.

[5] Zucrow, M. J., “Aircraft & Missile Propulsion”, Volume II, N.Y., John Wiley & Sons, Inc., 1958.

[6] Sutton, G. P., “Rocket Propulsion Elements”, 6th Edition, N.Y., John Wiley & Sons, Inc., 1992.

[7] Zucrow, M. J., “Aircraft and Missile Propulsion”, Volume I, N.Y., John Wiley & Sons, Inc., 1958.

[8] Hill, P. G., Peterson, C. P., “Mechanics and Thermodynamics of Propulsion”, Addison-Wesley Publication Company.

[9] Shapiro, A. H., “The Dynamics and Thermodynamics of Compressible Fluid Flow”, Volume I, N.Y., The Roland Press Company, Inc., 1953.

[10] Chasman, D., “New Design Criterion for Solid Rocket Motors.” Technical Note, Journal of Propulsion, Vol. 1, pp. 168-73, Washington D.C., January 2001.

[11] Oberg, E., Jones, F. D. and Horton, H. L., “Machinery's Handbook”, 23rd Edition, p. 66.

[12] Ellis, R. A. and Kearney, W., J., “Cylindrical Carbon-Carbon ITE (7-in. Billet Program)”, AFRPL TR-83-057, Edwards AFB, California, November 1983.

[13] Suhoza, J., P. and Gage, M., L., “Evaluation of Carbon-Carbon for Space Engine Nozzles, Phase II”, NAS8-37684, NASA, MSFC, February 1991.

[14] Uhrig, G., and Larrieu, J. M., “Towards an All Composite SCRAMJET Combustor”, AIAA 2002-3883, July, 2002.

[15] Gross, J. A., Leonhardt, T. A. and Hamister, M. J., “Rhenium Nozzle Throat Performance in a High-Pressure, Reduced-Smoke End-Burning Motor”, JANNAF, San Antonio, Tex., August 2002.

[16] Lacosta, M., Lacombe, P., Joyez, P., SEP and Ellis, R. A., Lee, J. C., Payne, F. M., Pratt&Whitney, “Carbon-Carbon Extendible Nozzles”, IAF-97-S.2.04, Turin, October, 1997.

[17] Timoshenko, S. P., and Gere , J. M., “Theory of Elastic Stability”, 2^{nd} Ed., McGraw-Hill, New York, 1961.

I claim:

1. A jet propulsion outlet device comprising:
a grid plate having a plurality of densely clustered nozzlettes, the nozzlettes of the grid plate being configured to operably couple to a pressurized gas source to efficiently expand the pressurized gas.

2. The jet propulsion outlet device of claim 1 wherein the plate is made from a material from the group consisting of glass reinforced phenolic composites, graphite reinforce phenolic composites, short strand reinforced phenolic composites, fiber reinforced ceramic matrix composite, and ceramic composites.

3. The jet propulsion outlet device of claim 1, wherein the nozzlettes are disposed in a pattern having a port to nozzlette ratio of greater than one.

4. The jet propulsion outlet device of claim 1, wherein the nozzlettes are made of a material that will remain substantially intact after having a gas stream having a pressure of 14,000 psi and a temperature of 2000° C. for 120 seconds passed through the nozzlettes.

5. The jet propulsion outlet device of claim 1, having at least one centrally disposed nozzlette surrounded by a plurality of peripheral nozzlettes, each of the plurality of peripheral nozzlettes abutting at least one central nozzlette and at least two other peripheral nozzlettes.

6. The jet propulsion outlet device of claim 1, wherein the nozzlettes are disposed in a pattern such that when a pressurized gas is passed through the nozzlettes, the pattern is substantially free of stagnation zones and the pressurized gas is not subjected to flow turning.

7. The jet propulsion outlet device of claim 1, wherein the convergent portion of the nozzlettes converges at an angle of less than 48°, and the divergent portion of the nozzlettes diverges at an angle of less than 30°.

8. A method of designing a nozzlette grid for channeling a gas comprising the steps of:
providing design parameters;
determining a required plate thickness based on the design parameters;
determining a geometry of an equivalent single nozzle;
defining geometric pattern to pack the nozzlettes in a tight arrangement; and
selecting a number of nozzlettes; wherein
the design for the nozzle grid defines a plate having the required plate thickness having the plurality of nozzlettes with the geometry of the equivalent single nozzle disposed in the geometric pattern.

9. The method of claim 7, wherein the design parameters include parameters related to mechanical and thermal stresses associated with the application of a gas to the nozzlette grid and the materials properties of a material.

10. The method of claim 7, wherein the geometric pattern is such that when a pressurized gas is passed through the nozzlettes, the defined plate is substantially free of stagnation zones and the gas is not subjected to flow turning.

11. A missile having improved aerodynamic stability comprising:
a payload and a propellant;
an engine comprising a plate having a plurality of nozzlettes disposed in a pattern that reduces stagnation zones in the engine;
a center of gravity of the payload, engine, and unexpelled propellant, the center of gravity being spaced from the engine;
a center of aerodynamic pressure, the center of aerodynamic pressure being located closer to the engine than the center of gravity.

12. A missile of claim 11, wherein the engine has a center of gravity that is further forward than that of an equivalent single nozzle engine made from the same material.

13. A missile comprising:
a payload and a propellant, the propellant being capable of being a pressurized gas;
an engine comprising a grid plate having a plurality of densely clustered nozzlettes, the nozzlettes of the grid plate being configured to operably couple to a pressurized gas source to efficiently expand the pressurized gas.

14. A missile of claim 13, wherein the engine has a mass less than that of an equivalent single nozzle engine made from the same material.

15. The missile of claim 13 wherein the plate is made from a material from the group consisting of glass reinforced phenolic composites, graphite reinforce phenolic composites, short strand reinforced phenolic composites, fiber reinforced ceramic matrix composite, and ceramic composites.

16. The missile of claim 13, wherein the nozzlettes are made of a material that will remain substantially intact after having a pressurized gas having a pressure of 14,000 psi and a temperature of 2000° C. for 120 seconds passed through the nozzlettes.

17. The missile of claim 13, having at least one centrally disposed nozzlette surrounded by a plurality of peripheral nozzlettes, each of the plurality of peripheral nozzlettes abutting at least one central nozzlette and at least two other peripheral nozzlettes.

18. The missile of claim 13, wherein the nozzlettes are disposed in a pattern such that when a pressurized gas is passed through the nozzlettes, the pattern is substantially free of stagnation zones and the pressurized gas is not subjected to flow turning.

19. The missile of claim 13, wherein the convergent portion of the nozzlettes converges at an angle of less than 48°, and the divergent portion of the nozzlettes diverges at an angle of less than 30°.
